(19) United States
(12) Patent Application Publication
(10) Pub. No.: US 2022/0088546 A1
(43) Pub. Date: Mar. 24, 2022

(54) Porous Membranes Including Triblock Copolymers

(71) Applicant: 3M INNOVATIVE PROPERTIES COMPANY, St. Paul, MN (US)

(72) Inventors: Michelle M. Mok, St. Paul, MN (US); Timothy M. Gillard, St. Paul, MN (US); Carl A. Laskowski, Minneapolis, MN (US); Lucas D. McIntosh, Minneapolis, MN (US); Hyacinth L. Lechuga, St. Paul, MN (US)

(21) Appl. No.: 17/425,409

(22) PCT Filed: Mar. 24, 2020
(86) PCT No.: PCT/IB2020/052772

§ 371 Date: Jul. 23, 2021

Related U.S. Application Data
(60) Provisional application No. 62/825,553, filed on Mar. 28, 2019.

(51) Int. Cl. B01D 71/80; B01D 71/52; B01D 71/26; B01D 71/28; B01D 69/08; B01D 67/00

(52) U.S. Cl. CPC B01D 71/80; B01D 71/52; B01D 71/26; B01D 71/28; B01D 2325/06; B01D 67/0023; B01D 2323/22; B01D 2325/022; B01D 69/08

(57) ABSTRACT

A porous membrane, The porous membrane includes a triblock copolymer of the formula ABC, the porous membrane comprising a plurality of pores; wherein the A block has a T_{g} of 90 degrees Celsius or greater and is present in an amount ranging from 30% to 80% by weight, inclusive, of the total block copolymer; wherein the B block has a T_{g} of 25 degrees Celsius or less and is present in an amount ranging from 10% to 40% by weight, inclusive, of the total block copolymer and wherein the C block is a water miscible hydrogen-bonding block immiscible with each of the A block and the B block; wherein the porous membrane comprising a first major surface and an opposed second major surface, wherein the first major surface is a nanostructured surface.

### BACKGROUND

Porous polymeric membranes are used as size-exclusion filters in a variety of industries, including water treatment, food and beverage preparation, and medical/biopharmaceutical purification. The biopharmaceutical industry places particularly rigorous demands on membranes, including high-temperature stability (e.g., 121° C. autoclave sterilization) and mechanical robustness. Polyethersulfone (PES) has been considered a state-of-the-art membrane material because it can meet or exceed the requirements for biopharmaceutical separations.

PES membranes are typically prepared via phase inversion processes (e.g., vapor- or solvent-induced phase separation (VIPS or SIPS)). The morphology of phase inversion membranes can be controlled through a combination of formulation and process conditions. Despite extensive formulation and process optimization, the performance of homopolymer-based membranes such as PES is ultimately limited by a wide distribution of pore sizes and shapes, especially at or near the relevant surface.

### SUMMARY

In one aspect, the present disclosure provides a porous membrane comprising a triblock copolymer of the formula ABC, the porous membrane comprising a plurality of pores;

wherein the A block has a T_{g} of 90 degrees Celsius or greater and is present in an amount ranging from 30% to 80% by weight, inclusive, of the total block copolymer; wherein the B block has a T_{g} of 25 degrees Celsius or less and is present in an amount ranging from 10% to 40% by weight, inclusive, of the total block copolymer and wherein the C block is a water miscible hydrogen-bonding block immiscible with each of the A block and the B block; wherein the porous membrane comprising a first major surface and an opposed second major surface, wherein the first major surface is a nanostructured surface.

In another aspect, the present disclosure provides a method of preparing a porous membrane, the method comprising: forming a film or a hollow fiber from a solution, the solution comprising a solvent and solids comprising an ABC triblock copolymer; removing at least a portion of the solvent from the film or the hollow fiber; and contacting the film or the hollow fiber with a nonsolvent, thereby forming the porous membrane comprising a plurality of pores; forming the porous membrane comprising a plurality of pores; wherein the A block has a T_{g} of 90 degrees Celsius or greater and is present in an amount ranging from 30% to 80% by weight, inclusive, of the total block copolymer; wherein the B block has a T_{g} of 25 degrees Celsius or less and is present in an amount ranging from 10% to 40% by weight, inclusive, of the total block copolymer and wherein the C block is a water miscible hydrogen-bonding block immiscible with each of the A block and the B block.

Various aspects and advantages of exemplary embodiments of the present disclosure have been summarized. The above Summary is not intended to describe each illustrated embodiment or every implementation of the present disclosure. Further features and advantages are disclosed in the embodiments that follow. The Drawings and the Detailed Description that follow more particularly exemplify certain embodiments using the principles disclosed herein.

### Definitions

For the following defined terms, these definitions shall be applied for the entire Specification, including the claims, unless a different definition is provided in the claims or elsewhere in the Specification based upon a specific reference to a modification of a term used in the following definitions:

The terms “about” or “approximately” with reference to a numerical value or a shape means+/−five percent of the numerical value or property or characteristic, but also expressly includes any narrow range within the +/−five percent of the numerical value or property or characteristic as well as the exact numerical value. For example, a temperature of “about” 100° C. refers to a temperature from 95° C. to 105° C., but also expressly includes any narrower range of temperature or even a single temperature within that range, including, for example, a temperature of exactly 100° C. For example, a viscosity of “about” 1 Pa-sec refers to a viscosity from 0.95 to 1.05 Pa-sec, but also expressly includes a viscosity of exactly 1 Pa-sec. Similarly, a perimeter that is “substantially square” is intended to describe a geometric shape having four lateral edges in which each lateral edge has a length which is from 95% to 105% of the length of any other lateral edge, but which also includes a geometric shape in which each lateral edge has exactly the same length.

The term “substantially” with reference to a property or characteristic means that the property or characteristic is exhibited to a greater extent than the opposite of that property or characteristic is exhibited. For example, a substrate that is “substantially” transparent refers to a substrate that transmits more radiation (e.g. visible light) than it fails to transmit (e.g. absorbs and reflects). Thus, a substrate that transmits more than 50% of the visible light incident upon its surface is substantially transparent, but a substrate that transmits 50% or less of the visible light incident upon its surface is not substantially transparent.

The terms “a”, “an”, and “the” include plural referents unless the content clearly dictates otherwise. Thus, for example, reference to a material containing “a compound” includes a mixture of two or more compounds.

### DETAILED DESCRIPTION

Before any embodiments of the present disclosure are explained in detail, it is understood that the invention is not limited in its application to the details of use, construction, and the arrangement of components set forth in the following description. The invention is capable of other embodiments and of being practiced or of being carried out in various ways that will become apparent to a person of ordinary skill in the art upon reading the present disclosure. Also, it is understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. It is understood that other embodiments may be utilized and structural or logical changes may be made without departing from the scope of the present disclosure.

As used in this Specification, the recitation of numerical ranges by endpoints includes all numbers subsumed within that range (e.g. 1 to 5 includes 1, 1.5, 2, 2.75, 3, 3.8, 4, and 5, and the like).

Unless otherwise indicated, all numbers expressing quantities or ingredients, measurement of properties and so forth used in the Specification and embodiments are to be understood as being modified in all instances by the term “about.” Accordingly, unless indicated to the contrary, the numerical parameters set forth in the foregoing specification and attached listing of embodiments can vary depending upon the desired properties sought to be obtained by those skilled in the art utilizing the teachings of the present disclosure. At the very least, and not as an attempt to limit the application of the doctrine of equivalents to the scope of the claimed embodiments, each numerical parameter should at least be construed in light of the number of reported significant digits and by applying ordinary rounding techniques.

The present disclosure provides porous membranes including triblock copolymers of the formula ABC. In certain embodiments, the porous membranes are prepared by solvent induced phase separation (SIPS) of an ABC triblock copolymer containing a glassy A block and rubbery B block. Under appropriate processing conditions, the triblock copolymers of the present disclosure tend to result in near isoporous features.

The porous membrane comprises an ABC triblock copolymer, and the membrane comprises a plurality of pores; the A block has a T_{g} of 90 degrees Celsius or greater and is present in an amount ranging from 30% to 80% by weight, inclusive, of the total block copolymer; wherein the B block has a T_{g} of 25 degrees Celsius or less and is present in an amount ranging from 10% to 40% by weight, inclusive, of the total block copolymer and wherein the C block is a water miscible hydrogen-bonding block immiscible with each of the A block and the B block.

The “A” block of the copolymer comprises polymeric units that form hard, glassy domains upon polymerization, with the A block having a T_{g} of at least 50° C., preferably at least 70° C., and more preferably at least 90° C. T_{g} can be determined using differential scanning calorimetry. The A block polymer domain comprises a total of 30 to 80 weight percent of the triblock copolymer.

The hard A blocks are typically selected from vinyl aromatic monomers and include, for example, styrene, α-methylstyrene, para-methylstyrene, 4-methylstyrene, 3-methylstyrene, 4-ethylstyrene, 3,4-dimethylstyrene, 2,4,6-trimethylstyrene, 3-tert-butyl-styrene, 4-tert-butylstyrene, 4-methoxystyrene, 4-trimethylsilylstyrene, 2,6-dichlorostyrene, vinyl naphthalene, and vinyl anthracene. Exemplary A blocks derived from vinyl aromatic monomers include for instance and without limitation, polystyrene, poly(p-methylstyrene), poly(alpha-methylstyrene), and poly(tert-butylstyrene). Exemplary A blocks not derived from vinyl aromatic monomers include polymethylmethacrylate.

It will be understood that “amorphous” blocks contain no or negligible amounts of crystallinity. In addition, the nature and composition of the monomers which make up the individual B block must also be selected to be the least polar of the three blocks of the triblock copolymer. Said another way, the B block is the most non-polar block of the triblock copolymer as defined by having the lowest Hildebrand solubility parameter. In some embodiments, the B block is free of polar group.

Exemplary B blocks include for instance and without limitation, polyisoprene, polybutadiene, polyisobutylene, polydimethylsiloxane, polyethylene, poly(ethylene-alt-propylene), poly(ethylene-co-butylene-co-propylene), polybutylene, and poly(ethylene-stat-butylene). In some embodiments, the B block comprises a polyacrylate or a polysiloxane.

The “B” block of the triblock copolymer is substantially free of functional groups. Additionally, each of such blocks B may have a number average molecular weight of at least 1000, at least 5000, at least 10000, at least 20000, at least 50000, and can be at most 200000, at most 160000, at most 100000, or 80000 at most. The B block may have a glass transition temperature, T_{g}, of <20° C., preferably <0° C. The soft “B” block comprises a total of 10 to 40 weight percent of the triblock block polymer. The combined A and B blocks comprise 70 to 95 weight percent of the triblock polymeric units.

The C blocks comprise a copolymer block immiscible in the A and B blocks. The immiscible components of the copolymer show multiple amorphous phases as determined, for example, by the presence of multiple amorphous glass transition temperatures using differential scanning calorimetry or dynamic mechanical analysis. As used herein, “immiscibility” refers to polymer components with limited solubility and non-zero interfacial tension, that is, a blend whose free energy of mixing is greater than zero:

ΔG≃ΔHₘ>0

Miscibility of polymers is determined by both thermodynamic and kinetic considerations. Common miscibility predictors for non-polar polymers are differences in solubility parameters or Flory-Huggins interaction parameters. For polymers with non-specific interactions, such as polyolefins, the Flory-Huggins interaction parameter can be calculated by multiplying the square of the solubility parameter difference with the factor (V/RT), where V is the molar volume of the amorphous phase of the repeated unit, R is the gas constant, and T is the absolute temperature. As a result, the Flory-Huggins interaction parameter between two non-polar polymers is always a positive number.

In addition to being immiscible in the A and B blocks, the C block comprises a water miscible copolymer block. A water miscible copolymer block is a copolymer block that if it was not covalently linked to A and B blocks, this is it existed as homopolymer, it would be soluble in water or swollen into a gel.

Water or majority water is most often used as the non-solvent bath in the SIPS process due to its applicability for phase inverting a wide variety of polymer systems, miscibility with many solvent systems which would be used to solubilize said polymers, and also due to its ease of handling compared to more flammable or toxic solvents. The current porous membaran shows the surprising result where SIPS becomes challenging, when the combination of non-polar rubbery block location and the choice of hydrophilic block in a block copolymer system can interfere with the precipitation process during solvent inversion. Previously, polyisoprene-polystyrene-poly(4-vinyl pyridine) membranes have been demonstrated through the use of the SIPS process (U.S. Pat. No. 9,527,041). In the comparative examples however, it is shown that with the change in hydrophilic moiety to water miscible polyethylene oxide, the polyisoprene-polystyrene-polyethylene oxide triblock copolymer does not precipitate in a SIPS process when water is used as the non-solvent, but rather forms a clear gelled system. However, with a change in block ordering, where the least polar block is a midblock—polystyrene-polyisoprene-polyethylene oxide-precipitating structures with near-isoporous structures are enabled.

In certain embodiments, the C block comprises a poly(alkylene oxide), a substituted epoxide, a polylactam, or a substituted carbonate. Exemplary C blocks include for instance and without limitation, poly(ethylene oxide), poly(D/L-propylene oxide), poly(D-propylene oxide), poly(L-propylene oxide), polyacrylamide, polyacrylic acid, poly(methacrylic acid), and polyhydroxyethylmethacrylate.

The nature and composition of the monomers which make up the individual hard A block, nonpolar rubbery B block, and water miscible C block must be chosen such that the Hildebrand solubility parameter of the B block is the smallest and the solubility parameter of the C block is the largest, wherein the resulting Flory-Huggins interaction parameter between the B and the C blocks is larger than both the Flory-Huggins interaction parameter between A and C blocks and the Flory-Huggins interaction parameter between A and B blocks.

ABC triblock copolymers may be prepared from any number of controlled polymerization methodologies or combination thereof. These include radical addition-fragmentation (RAFT), atom transfer polymerization (ATRP), group transfer polymerization (GTP), nitroxide mediated polymerization (NMP), and anionic polymerization. Of particular industrial relevance is anionic polymerization. Anionic polymerizations and copolymerizations include at least one polymerization initiator. Initiators compatible with the monomers of the instant copolymers are summarized in Hsieh et al., Anionic Polymerization: Principles and Practical Applications, Ch. 5 and 23 (Marcel Dekker, New York, 1996). The initiator can be used in the polymerization mixture (including monomers and solvent) in an amount calculated on the basis of one initiator molecule per desired polymer chain. The lithium initiator process is well known and is described in, for example, U.S. Pat. No. 4,039,593 (Kamienski, et al.) and U.S. Pat. Re. No. 27,145 (Jones).

Suitable initiators include alkali metal hydrocarbons (e.g., as alkyl or aryl lithium, sodium, or potassium compounds) containing up to 20 carbon atoms in the alkyl or aryl radical or more; preferably up to 8 carbon atoms. Examples of such compounds are benzylsodium, ethylsodium, propylsodium, phenylsodium, butylpotassium, octylpotassium, benzylpotassium, benzyllithium, methyllithium, ethyllithium, n-butyllithium, sec-butyllithium, tert-butyllithium, phenyllithium, and 2-ethylhexyllithium. Lithium compounds are preferred as initiators.

Molecular weight is determined by the initiator/monomer ratio, and thus the amount of initiator may vary from about 0.0001 to about 0.2 mole of organometallic initiator per mole of monomer. Preferably, the amount will be from about 0.0005 to about 0.04 mole of initiator per mole of monomer. For the initiation of carbon-centered anionic polymerization, an inert, preferably nonpolar, organic solvent can be utilized. Anionic polymerization of cyclic monomers that yield an oxygen-centered anion and lithium cation may require either a strong polar solvent such as tetrahydrofuran, dimethyl sulfoxide, or hexamethylphosphorous triamide, or a mixture of such polar solvent with nonpolar aliphatic, cycloaliphatic, or aromatic hydrocarbon solvent such as hexane, heptane, octane, cyclohexane, or toluene.

Generally, the polymerization can be carried out at a temperature in a range from about −78° C. to about 100° C. (in some embodiments, in a range from about 0° C. to about 60° C.). Anhydrous conditions and an inert atmosphere such as nitrogen, helium, or argon are typically required.

Termination of the anionic polymerization is, in general, achieved via direct reaction of the living polymeric anion with protic solvents. Termination with halogen-containing terminating agents (i.e., functionalized chlorosilanes) can produce, for example, vinyl-terminated polymeric monomers. The termination reaction is carried out by adding a slight molar excess of the terminating agent (relative to the amount of initiator) to the living polymer at the polymerization temperature.

It is recognized that transitioning from a carbon-centered propagating anion to an oxygen-centered propagating anion can be used as a method for terminating an anionic polymerization of vinyl aromatics or conjugated dienes. For example, addition of oxiranes like ethylene oxide to the styrenic anion produced during styrene polymerization can lead to end-capping of the polymer chain with a hydroxyl, oxygen-centered anionic functionality. The reduced nucleophilicity of the oxygen-centered anion prevents further polymerization of any vinyl aromatic or conjugated diene present, thus ethylene oxide acts as a terminating agent in one sense, yet also forms an initiator for further ring-opening polymerizations (as in Hsieh et al., Anionic Polymerization: Principles and Practical Applications, Ch. 5 and 23 (Marcel Dekker, New York, 1996)).

In some embodiments, the A block comprises a polystyrene, the B block comprises a polyisoprene and the C block comprises a poly(ethylene oxide).

The porous membrane of the present disclosure includes a first major surface and an opposed second major surface. The first major surface can be a nanostructured surface and the nanostructured surface can have a plurality of anisotropic nanostructures (nanoscale features) or nanoscale phase separated regions. Generally, the nanostructured surface can have a nanostructured anisotropic surface. The nanostructured anisotropic surface typically can comprise nanoscale features. In some embodiments, the nanostructured anisotropic surface can comprise anisotropic nanoscale features. In some embodiments, the nanostructured anisotropic surface can comprise random anisotropic nanoscale features. The nanostructured anisotropic surface typically can comprise nanoscale features having a height to width ratio (aspect ratio) about 2:1 or greater; preferably about 5:1 or greater. In some embodiments, the height to width ratio can even be 50:1 or greater, 100:1 or greater, or 200:1 or greater. The nanostructured anisotropic surface can comprise nanoscale features such as, for example, nano-pillars or nano-columns, or continuous nano-walls comprising nano-pillars or nano-columns. Typically, the nanoscale features have steep side walls that are substantially perpendicular to the substrate. In some embodiments, the nanostructured surface has a density of 1×10¹³-1×10¹⁵ nanostructures per cm². In some embodiments, the size (for example, the height) of nanostructures can be 10-50 nm.

In certain embodiments, porous membranes prepared according to the present disclosure include pores that change in size from one surface, through the thickness of the membrane, to the opposing surface. For instance, often a pore size is on average smallest at one surface, increases throughout the body of the membrane, and is on average largest at the opposite surface. Process conditions and specific solution formulations can be selected to provide a porous membrane in which the pores at one surface (or both major surfaces) of the membrane have an average pore size of 1 nanometer (nm) or greater, 5 nm or greater, 10 nm or greater, 20 nm or greater, 30 nm or greater, or 40 nm or greater; and 500 nm or less, 450 nm or less, 400 nm or less, 350 nm or less, 300 nm or less, 250 nm or less, 200 nm or less, or 150 nm or less. Stated another way, the surface pores (e.g., pores located on at least one membrane surface) may have an average pore size ranging from 1 nm to 500 nm, inclusive, or from 5 nm to 50 nm, inclusive.

In select embodiments, the membrane is isoporous (i.e., having approximately the same pore size) or near-isoporous. For an isoporous membrane, in some embodiments a standard deviation in pore diameter at a surface of the membrane (e.g., surface pore diameter) is 4 nm or less from a mean pore diameter at the surface of the membrane when the mean pore diameter at the surface of the membrane ranges from 5 to 15 nm, the standard deviation in pore diameter at the surface of the membrane is 6 nm or less from the mean pore diameter at the surface of the membrane when the mean pore diameter at the surface of the membrane ranges from greater than 15 to 25 nm, and the standard deviation in pore diameter at the surface of the membrane is 25% or less of the mean pore diameter at the surface of the membrane when the mean pore diameter at a surface of the membrane ranges from greater than 25 to 50 nm. The mean surface pore diameter is the average diameter of the pores at a surface of the membrane, as opposed to pores within the body of the membrane. Further, an isoporous membrane may have a pore density of 1×10¹⁴ pores per square meter or greater.

In select embodiments the membrane is free-standing, whereas in alternate embodiments the membrane is disposed on a substrate. Suitable substrates include for example and without limitation, polymeric membranes, nonwoven substrates, porous ceramic substrates, and porous metal substrates. Optionally, the membrane comprises a hollow fiber membrane, in which the membrane has a hollow shape. In certain embodiments, the hollow fiber membrane can be disposed on a substrate that has a hollow shape. The membrane may be either symmetric or asymmetric, for instance depending on a desired application. The porous membrane typically has a thickness ranging from 5 micrometers to 500 micrometers, inclusive.

When using alkyl lithium initiators, this disclosure provides a method of preparing the triblock copolymers comprising the steps of (a) anionically polymerizing the A block monomer, (b) polymerizing the B block monomer, (c) polymerizing the C block monomer and (d) terminating the polymerization. The method may be illustrated as follows where R is the residue of the initiator.

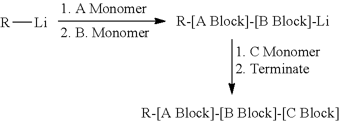

Functional anionic initiators can also be used to provide end-functionalized polymers. These initiators are typically suitable for initiating the recited monomers using techniques known to those skilled in the art. Various functional groups can be incorporated onto the end of a polymer chain using this strategy including: alcohol(s), thiol(s), carboxylic acid, and amine(s). In each of these cases, the initiator must contain protected functional groups that can be removed using post polymerization techniques. Suitable functional initiators are known in the art and are described in, for example, U.S. Pat. No. 6,197,891 (Schwindeman et al.), 6,160,054 (Periera et al.), 6,221,991 (Letchford et al.), 6,184,338 (Schwindeman et al.), and 5,321,148 (Schwindeman et al.), the disclosures of which are incorporated herein by reference thereto.

These initiators contain tertiary alkyl or trialkylsilyl protecting groups that can be removed by post-polymerization deprotection. Tert-alkyl-protected groups can also be removed by reaction of the polymer with para-toluenesulfonic acid, trifluoroacetic acid, or trimethylsilyliodide to produce alcohol, amino, or thiol functionalities. Additional methods of deprotection of the tert-alkyl protecting groups can be found in T. W. Greene and P. G. M. Wuts, Protective Groups in Organic Synthesis, Second Edition, Wiley, New York, 1991, page 41. Tert-butyldimethylsilyl protecting groups can be removed by treatment of the polymer with acid, such as hydrochloric acid, acetic acid, or para-toluenesulfonic acid. Alternatively, a source of fluoride ions, for instance tetra-n-butylammonium fluoride, potassium fluoride and 18-crown-6, or pyridine-hydrofluoric acid complex, can be employed for deprotection of the tert-butyldimethylsilyl protecting groups. Additional methods of deprotection of the tert-butyldimethylsilyl protecting groups can be found in T. W. Greene and P. G. M. Wuts, Protective Groups in Organic Synthesis, Second Edition, Wiley, New York, 1991, pp. 80-83.

When using a functional initiator, this disclosure provides a method of preparing the triblock copolymer comprising the steps of (a) anionically polymerizing the B block monomer using a functionalized initiator, (b) polymerizing the A block monomer, (c) terminating the polymerization, (d) deprotecting the residue of the functionalized initiator, (e) polymerizing the C block and (e) terminating the polymerization.

This method may be illustrated as follows:

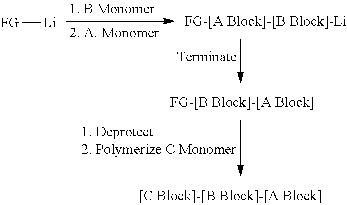

End capping with terminating agents can also be used to provide end-functionalized polymers that can be used as initiators for further polymerization. For example, addition of oxiranes like ethylene oxide to the styrenic anion produced during styrene polymerization can lead to end-capping of the polymer chain with a hydroxyl, oxygen-centered anionic functionality. The reduced nucleophilicity of the oxygen-centered anion prevents further polymerization of any vinyl aromatic or conjugated diene present, thus ethylene oxide acts as a terminating agent in one sense, yet also forms an initiator for further ring-opening polymerizations (as in Hsieh et al., Anionic Polymerization: Principles and Practical Applications, Ch. 5 and 23 (Marcel Dekker, New York, 1996)).

When using end capping, this disclosure provides a method of preparing the triblock copolymers comprising the steps of (a) anionically polymerizing the A block monomer, (b) anionically polymerizing the B block monomer, (c) end capping the B block with a functional group by terminating the polymerization with a terminating agent (d) polymerizing the C block monomer (d) terminating the polymerization. The method may be illustrated as follows where R is the residue of the initiator.

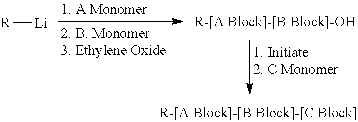

Disclosed triblock copolymers can also be used to prepare porous membranes. Porous membranes can be prepared using solvent induced phase separation (SIPS) or vapor induced phase separation (VIPS) methods.

As noted above, a method of making a porous membrane is provided, and comprises: forming a film or a hollow fiber from a solution, the solution comprising a solvent and solids comprising an ABC block copolymer; removing at least a portion of the solvent from the film or the hollow fiber; and contacting the film or the hollow fiber with a nonsolvent, thereby forming the porous membrane comprising a plurality of pores. SIPS methods of forming porous membranes have been known, such as described in U.S. Pat. No. 3,133,132 (Loeb et al.) and 3,283,042 (Loeb et al.). For example, in certain embodiments forming the film comprises casting the solution on a substrate, whereas in other embodiments forming the hollow fiber comprises spinning the solution into the hollow fiber.

The amount of solvent present is not particularly limited, and may include 65 weight percent (wt. %) solvent or greater, 70 wt. % solvent or greater, or 70 wt. % solvent or greater; and 95 wt. % solvent or less, 90 wt. % solvent or less, or 85 wt. % solvent or less. The weight percent of solvent is based on the total weight of the solution. Stated another way, the solvent may be present in an amount ranging from 65 to 95 wt. % of the total solution, inclusive, 70 to 90 wt. % of the total solution, inclusive, or 85 to 95 wt. % of the total solution, inclusive. Some exemplary solvents for use in the method include dimethylformamide, dimethylacetamide, N-methylpyrrolidone, dimethylsulfoxide, tetrahydrofuran, 1,4-dioxane, 1,3-dioxane, tetrahydrothiophene 1,1-dioxide, methyl ethyl ketone, methyl tetrahydrofuran, sulfolane, and combinations thereof.

Typically, removing at least a portion of the solvent from the cast solution comprises evaporating at least a portion of the solvent from the cast solution for a time of 10 millisecond or greater, 50 milliseconds or greater, 500 milliseconds or greater, 1 second or greater, 5 seconds or greater, 10 seconds or greater, or 20 seconds or greater; and 120 seconds or less, 100 seconds or less, 80 seconds or less, 60 seconds or less, 40 seconds or less, or 30 seconds or less. Stated another way, removing at least a portion of the solvent from the cast solution can comprise evaporating at least a portion of the solvent from the cast solution for a time of ranging from 10 millisecond to 120 seconds, inclusive, 10 millisecond to 30 seconds, 20 seconds to 60 seconds, or 40 seconds to 120 seconds, inclusive.

The skilled practitioner is familiar with nonsolvents; in certain embodiments of the method, the nonsolvent comprises water. Optionally, the solids further comprise at least one additive. For example, such additives may comprise for instance and without limitation, one or more of a homopolymer, a diblock polymer, or triblock polymer in an amount ranging from 1 to 49 wt. % of the total solids, inclusive.

In certain embodiments, the solids make up less than a majority of the total solution. For instance, the solids are usually included in an amount of 5 wt. % or greater, 10 wt. % or greater, 15 wt. % or greater, or 20 wt. % or greater; and 35 wt. % or less, 30 wt. % or less, or 25 wt. % or less. Stated another way, the solids may be present in an amount ranging from 5 to 35 wt. %, or from 10 to 30 wt. % of the total solution, inclusive.

The following embodiments are intended to be illustrative of the present disclosure and not limiting.

### EMBODIMENTS

Embodiment 1 is a porous membrane comprising a triblock copolymer of the formula ABC, the porous membrane comprising a plurality of pores; wherein the A block has a T_{g} of 90 degrees Celsius or greater and is present in an amount ranging from 30% to 80% by weight, inclusive, of the total block copolymer; wherein the B block has a T_{g} of 25 degrees Celsius or less and is present in an amount ranging from 10% to 40% by weight, inclusive, of the total block copolymer and wherein the C block is a water miscible hydrogen-bonding block immiscible with each of the A block and the B block; wherein the porous membrane comprising a first major surface and an opposed second major surface, wherein the first major surface is a nanostructured surface.

Embodiment 2 is the porous membrane of embodiment 1, wherein the nanostructured surface comprises a plurality of anisotropic nanostructures or nanoscale phase separated regions.

Embodiment 3 is the porous membrane of any of embodiments 1 or 2, wherein the nanostructured surface has a density of 1×10¹³-1×10¹⁵ nanostructures per cm².

Embodiment 4 is the porous membrane of any of embodiments 1 to 3, wherein the A block comprises a polystyrene.

Embodiment 5 is the porous membrane of any of embodiments 1 to 4, wherein the B block comprises a polyisoprene.

Embodiment 6 is the porous membrane of any of embodiments 1 to 5, wherein the C block comprises a poly(ethylene oxide).

Embodiment 7 is the porous membrane of any of embodiments 1 to 6, wherein the membrane is isoporous.

Embodiment 8 is the porous membrane of any of embodiments 1 to 7, wherein the porous membrane is an integral asymmetric membrane.

Embodiment 9 is a method of preparing a porous membrane, the method comprising: forming a film or a hollow fiber from a solution, the solution comprising a solvent and solids comprising an ABC triblock copolymer; removing at least a portion of the solvent from the film or the hollow fiber; and contacting the film or the hollow fiber with a nonsolvent, thereby forming the porous membrane comprising a plurality of pores; forming the porous membrane comprising a plurality of pores; wherein the A block has a T_{g} of 90 degrees Celsius or greater and is present in an amount ranging from 30% to 80% by weight, inclusive, of the total block copolymer; wherein the B block has a T_{g} of 25 degrees Celsius or less and is present in an amount ranging from 10% to 40% by weight, inclusive, of the total block copolymer and wherein the C block is a water miscible hydrogen-bonding block immiscible with each of the A block and the B block.

Embodiment 10 is the method of embodiment 9, wherein the A block comprises a polystyrene, the B block comprises a polyisoprene and the C block comprises a poly(ethylene oxide).

Embodiment 11 is the method of embodiment 9 or 10, wherein the solvent is selected from the group consisting of dimethylformamide, dimethylacetamide, N-methylpyrrolidone, dimethylsulfoxide, tetrahydrofuran, 1,4-dioxane, 1,3-dioxane, tetrahydrothiophene 1,1-dioxide, methyl ethyl ketone, methyl tetrahydrofuran, sulfolane, and combinations thereof.

Embodiment 12 is the method of any of embodiments 9 to 11, wherein the solvent is a blend of 70/30 methyl ethyl ketone and dimethylformamide.

Embodiment 13 is the method of any of embodiments 9 to 12, further comprising removing at least a portion of the solvent between 10 milliseconds and 2 mins.

Embodiment 14 is the method of any of embodiments 9 to 13, wherein forming the film comprises casting the solution on a substrate.

Embodiment 15 is the porous membrane of any embodiments 1 and 14, wherein the Hildebrand solubility parameter of the A block and C block are greater than that of the B block.

Embodiment 16 is the porous membrane of any embodiments 1 and 15, wherein the Hildebrand solubility parameter of the C block is greater than that of the A block.

Embodiment 17 is the method of embodiment 9, wherein the nonsolvent is water.

Embodiment 18 is the method of embodiment 9, wherein the nonsolvent is water containing dissolved salts.

Embodiment 19 is the method of embodiment 9, wherein the nonsolvent is water at temperature >30° C.

The following working examples are intended to be illustrative of the present disclosure and not limiting.

### EXAMPLES

Synthesis of Block Copolymer Materials

General Considerations:

Polymer synthesis and reagent purifications were conducted, interchangeably, in a glovebox (obtained under the trade designation “MBRAUN LABMASTER SP” from M. Braun USA, Inc., Stratham, N.H.), or in custom glassware designed to enable anionic polymerizations (such as those disclosed in Ndoni, S., Papadakis, C. M., Bates, F. S., and Almdal, K.: Laboratory-scale Setup for Anionic Polymerization under Inert Atmosphere. Review of Scientific Instruments 1995, 66 (2), 1090-1095 DOI: 10.1063/1.1146052). It is believed that results for any given synthesis are not affected by which of the methods was employed. Standard air-exclusion techniques were used for anionic polymerization and reagent manipulations. Reagents and corresponding suppliers are listed below in Table 1.

TABLE 1

| Abbreviation | | | |
|---|---|---|---|
| or Chemical Name | Description | Product Code | Source |
| Isoprene | | L14619 | Alfa Aesar., Ward Hill, MA |
| Styrene | | S4972, obtained | Sigma-Aldrich Co. LLC., St. |
| | | under the trade | Louis, MO |
| | | designation | |
| | | “REAGENTPLUS” | |
| TBDMSPL (Tert-butyl- | 1.04M in | — | FMC Lithium, Charlotte, NC |
| dimethylsiloxy-propyl- | cyclohexane | | |
| 1-lithium) | | | |
| Benzene | | BX0212-6, obtained | EMD Millipore, Burlington, |
| | | under the trade | MA |
| | | designation | |
| | | “OMNISOLV” | |
| Methylene Chloride | | DX083I-1, obtained | EMD Millipore, Burlington, |
| | | under the trade | MA |
| | | designation | |
| | | “OMNISOLV” | |
| THF (Tetrahydrofuran) | anhydrous, ≥99.9%, | 401757 | Sigma-Aldrich Co. LLC., St. |
| | inhibitor-free | | Louis, MO |
| TBAF | 1.0M in | 216143 | Sigma-Aldrich Co. LLC., St. |
| (Tetrabutylammonium | tetrahydrofuran | | Louis, MO |
| Fluoride) | | | |
| Ethylene Oxide | | 387614 | Sigma Aldrich Co. LLC., St. |
| | | | Louis, MO |
| Sec-butyllithium | 12 wt. % in | 718-01 | FMC Lithium, Charlotte, NC. |
| | cyclohexane | | |
| Di-n-butylmagnesium | 1.0M in | 345113 | Sigma Aldrich Co. LLC., St. |
| | Heptane | | Louis, MO |
| Methanol | | MX0480-6, obtained | EMD Millipore, Burlington, |
| | | under the trade | MA |
| | | designation | |
| | | “OMNISOLV” | |
| Potassium | Potassium, | 679909 | Sigma Aldrich Co. LLC., St. |
| | cubes (in | | Louis, MO |
| | mineral oil), L × | | |
| | W × H 40 mm × | | |
| | 30 mm × 20 | | |
| | mm, 99.5% | | |
| | trace metals | | |
| | basis. | | |
| Naphthalene | | 33347 | Alpha Aesar, Ward Hill, MA |
| Diphenylethylene (1,1- | | A14434 | Alfa Aesar, Ward Hill, MA |
| Diphenylethylene) | | | |
| n-butyllithium | 24 wt % in | 703-02 | FMC Lithium, Charlotte, NC |
| | hexanes | | |
| Isopropanol (Isopropyl | | BDH1133 | VWR Analytical, Radnor, PA |
| Alcohol) | | | |
| Glacial Acetic Acid | | AX0073-75 | EMD Millipore, Burlington, MA |
| CaH₂ (Calcium Hydride | | A16242 | Alfa Aesar, Ward Hill, MA |

Reagent Drying

Benzene was degassed by bubbling with Argon (Ar) for longer than one hour before being cannula-transferred to a Strauss flask containing degassed 1,1-diphenylethylene. Sec-butyllithium was then added under Ar counterflow via syringe, causing a very gradual color change from light yellow to deep, wine red over the course of an hour. After stirring overnight, benzene was vacuum transferred to an addition funnel. Methylene chloride was dried over CaH₂, degassed with three freeze-pump-thaw cycles, and vacuum-transferred into a receiving flask. Styrene was stirred over CaH₂ overnight, degassed with three freeze-pump-thaw cycles, and then vacuum-transferred into a Schlenk bomb containing dried dibutyl-magnesium. After stirring overnight in an Ar atmosphere, styrene was again vacuum-transferred into a receiving flask to afford a final, dry monomer. Isoprene was dried as detailed above for styrene with sequential vacuum transfers from CaH₂ and dibutyl-magnesium.

Ethylene oxide was condensed in a receiving flask cooled with liquid nitrogen, degassed by at least three freeze-pump-thaw cycles taking care not to warm the ethylene oxide above its boiling point (10.7° C.), vacuum transferred to a flask containing dried n-butyllithium (solvent removed from the n-butyllithium by vacuum drying prior to ethylene oxide transfer) and stirred at 0° C. for at least 30 min, vacuum transferred to a second flask containing dried n-butyllithium and stirred at 0° C. for at least an additional 30 min, and finally vacuum transferred to a flame dried monomer flask suitable for connection to the polymerization reactor. Tetrahydrofuran used as solvent for polymerizations was purified via solvent purification system (obtained under the trade designation “COMPACT” from Pure Process Technology LLC, Nashua, N.H.).

All other chemicals were used as received.

Gel Permeation Chromatography (GPC)

Tetrahydrofuran (THF, stabilized with 250 ppm butylated hydroxy toluene (BHT)) was used as solvent and mobile phase. Solutions of known concentration were prepared in glass scintillation vials; the target concentration was about 5.0 mg/mL. The vials were swirled for at least 4 hours in order to allow dissolution. The solutions were then filtered using 0.2 μm PTFE syringe filters. A gel permeation chromatography system (obtained under the trade designation “1260 LC” from Agilent Technologies, Santa Clara, Calif.) equipped with a column set (obtained under the trade designations “PLGEL MIXED A, and “PLGEL MIXED B” from Agilent Technologies, Santa Clara, Calif.), an 18 angle light scattering detector (obtained under the trade designation “DAWN HELEOS-II” from Wyatt Technology Corporation, Santa Barbara, Calif.), a viscometer detector (obtained under the trade designation “VISCOSTAR II” from Wyatt Technology Corporation, Santa Barbara, Calif.), and a differential refractive index (DRI) detector (obtained under the trade designation “OPTILAB REX” from Wyatt Technology Corporation, Santa Barbara, Calif.) was used. The columns' dimensions were 300 mm by 7.5 mm I.D. The GPC conditions were as follows:
Column Heating: 40° C.
Mobile Phase: THF, stabilized with 250 ppm BHT at 1.0 mL/min
Injection Volume: 40 μL

Software (obtained under the trade designation “ASTRA 6” from Wyatt Technology Corporation, Santa Barbara, Calif.) was used for data collection and analysis. A narrow standard of polystyrene of about 30 kg/mol was used for normalization of the light scattering detectors and for measuring the inter-detector volume.

NMR

A portion of the polymer sample was analyzed as a solution of unknown concentration (of about 10 mg/mL) in deuterated chloroform solvent (CDCl₃) (obtained from Cambridge Isotope Laboratories, Inc., Andover, Mass.). One dimensional (1D) proton NMR data were collected using a 500 MHz NMR spectrometer (obtained under the trade designation “AVANCE” from Bruker, Billerica, Mass. equipped with a cryogenically cooled probe head. One of the residual proteo-solvent resonances was used as a secondary chemical shift reference in the proton dimension (3=7.24 ppm). All of the NMR data were collected with the sample held at 25° C.

Preparation of Hydroxyl-Terminated Poly(Styrene-Isoprene-Styrene) Block Copolymer (HO-SIS-OH) Using Sequential Addition and Ethylene Oxide Termination

HO-SIS-OH block copolymers were prepared by the procedure described in PCT Pat. Publ. No. WO 2018/098023, pages 19-20, with differences in monomer and initiator ratios necessary to obtain the desired polymer molecular weights and compositions. Polymer composition was determined by ¹H-NMR, and polymer molecular weight and polydispersity index (PDI) were determined by GPC analysis. Results are summarized in Table 2.

TABLE 2

| | Mass % | Mass % | GPC Mw | |
|---|---|---|---|---|
| Sample ID | Isoprene | Styrene | (kg/mol) | GPC PDI |
| SIS-012 | 29.0 | 71.0 | 184 | 1.10 |
| SIS-024 | 34.0 | 66.0 | 92 | 1.06 |

Preparation [of Hydroxyl-Terminated Poly(Isoprene-Styrene-Isoprene) Block Copolymer (HO-ISI-OH) Using Sequential Addition and Ethylene Oxide Termination

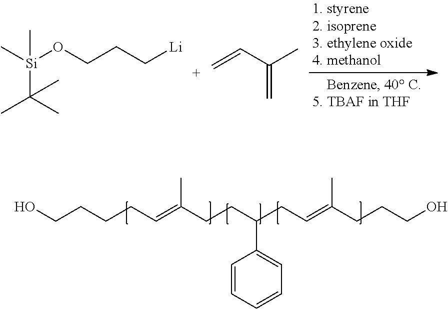

A 2 L polymerization reactor apparatus was constructed and inert Ar atmosphere established. 666 g of purified benzene was added to the reactor. TBDMSPL protected initiator (0.45 mL) was then added to the reactor and stirred for 30 minutes. Purified isoprene (10.1 g) was then added to the reactor. After reacting for approximately 1 hr at room temperature, the reactor was heated to 40° C. via a water bath. Approximately 5 hrs after the addition of isoprene, purified styrene (37.1 g) was added to the reactor. Approximately 18 hrs after the addition of styrene, a second amount of purified isoprene (10.1 g) was added to the reactor. Approximately 5 hrs after the second addition of isoprene, a large molar excess (2 g) of ethylene oxide was added to the reactor. The reactor was then allowed to cool to room temperature. Approximately 72 hrs after the addition of ethylene oxide, the reaction was terminated with degassed methanol to yield a monohydroxyl end-functional RO-ISI-OH triblock copolymer.

To yield a dihydroxyl terminal ISI triblock copolymer (HO-ISI-OH), benzene solvent was removed by rotary evaporation and the resulting polymer was dissolved in 400 mL of tetrahydrofuran. A 10× molar excess of TBAF relative to the initiator was added to the THF solution (4.5 mL of 1.0 M TBAF in THF) and the solution was stirred at room temperature for at least 18 hrs. The THF solvent was removed by rotary evaporation and the resulting polymer was dissolved in 400 mL of methylene chloride. The methylene chloride solution was washed with several 300 mL aliquots of distilled water. The methylene chloride was removed by rotary evaporation and the polymer was redissolved in about 400 mL of THF and the solution was precipitated from an isopropanol/methanol mixture (1:3 by volume) and the resulting white solid was isolated by filtration and dried in vacuo to yield 55 g of dried polymer designated ISI-058.

Polymer composition was determined by ¹H-NMR, polymer molecular weight and polydispersity index by GPC analysis. Details are given in Table 3.

TABLE 3

| | Mass % | Mass % | GPC Mw | |
|---|---|---|---|---|
| Sample ID | Isoprene | Styrene | (kg/mol) | GPC PDI |
| ISI-058 | 35 | 65 | 181 | 1.03 |

Preparation of Hydroxyl-Terminated Poly(Isoprene-Styrene) Block Copolymer (IS-OH) Using a Sequential Addition and Ethylene Oxide Termination

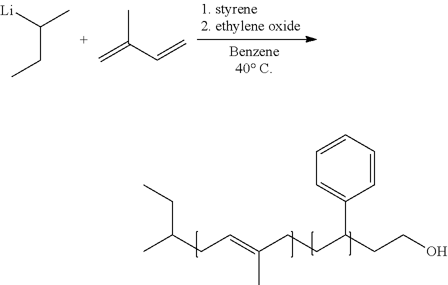

A 2 L polymerization reactor apparatus was constructed and inert Ar atmosphere established. Purified benzene (551 g) was added to the reactor and the reactor was heated to 40° C. via a water bath. Sec-butyllithium initiator solution (0.45 mL, 1.4 M in hexanes) was then added to the reactor and stirred for 30 minutes. Purified isoprene (21.1 g, 311 mmol) was then added to the reactor. Approximately 24 hrs after the addition of isoprene, 38.9 g (373 mmol) of styrene was added to the reactor resulting in an immediate color change from pale yellow to orange. Approximately 24 hrs after the addition of styrene, a large molar excess (2 g; 45 mmol) of ethylene oxide was added to the reactor resulting in a color change from orange to colorless. The reactor was allowed to cool to room temperature. At least 16 hrs after the addition of ethylene oxide, the reaction was terminated with degassed methanol to yield a monohydroxyl end functional IS-OH diblock copolymer designated IS-023. The polymer was isolated by precipitation from methanol, filtration to remove the majority of the methanol and benzene solvents, and drying in a vacuum oven to remove remaining residual solvents. IS-011 precursor was synthesized as described for IS-023, except for differences in monomer and initiator ratio to obtain different polymer molecular weight and composition.

Polymer composition was determined by ¹H-NMR, polymer molecular weight and polydispersity index by GPC analysis. Details are given in Table 4.

TABLE 4
Composition and GPC data for IS-OH prepared
by ethylene oxide end-capping.

| | Mass % | Mass % | GPC Mw | |
|---|---|---|---|---|
| Sample ID | Isoprene | Styrene | (kg/mol) | GPC PDI |
| IS-011 | 31.0 | 69.0 | 118 | 1.02 |
| IS-023 | 36.0 | 64.0 | 94 | 1.01 |

Preparation of Hydroxyl-Terminated Poly(Styrene-Isoprene) Block Copolymer (SI-OH) Using a Sequential Addition and Ethylene Oxide Termination

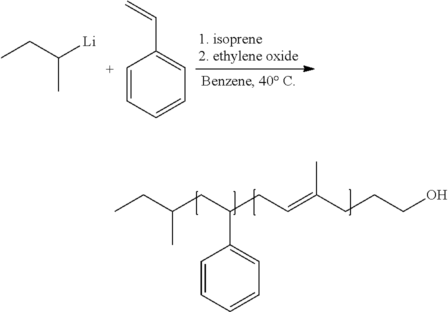

A 2 L polymerization reactor apparatus was constructed and inert Ar atmosphere established. Purified benzene (637 g) was added to the reactor and the reactor was heated to 40° C. via a water bath. Sec-butyllithium initiator solution (0.51 mL, 1.4 M in hexanes) was then added to the reactor and stirred for 30 minutes. Purified styrene (36.0 g) was then added to the reactor resulting in an immediate color change to orange. Approximately 24 hrs after the addition of styrene, purified isoprene (17.1 g) was added to the reactor resulting in an immediate color change from orange to pale yellow. Approximately 24 hrs after the addition of styrene, a large molar excess (2 g) of ethylene oxide was added to the reactor resulting in a color change from orange to colorless. The reactor was allowed to cool to room temperature. After the addition of ethylene oxide, the reaction was terminated with degassed methanol to yield a monohydroxyl end functional SI-OH diblock copolymer designated SI-052. The polymer was isolated by precipitation from methanol, filtration to remove the majority of the methanol and benzene solvents, and drying in a vacuum oven to remove remaining residual solvents.

Polymer composition was determined by ¹H-NMR, polymer molecular weight and polydispersity index by GPC analysis. Details are given in Table 5.

TABLE 5

| | Mass % | Mass % | GPC Mw | |
|---|---|---|---|---|
| Sample ID | Isoprene | Styrene | (kg/mol) | GPC PDI |
| SI-052 | 31.0 | 69.0 | 118 | 1.02 |

Preparation of Hydroxyl-Terminated Poly(Styrene-Isoprene) Block Copolymer (SI-OH) Using a Sequential Addition and a Protected Initiator

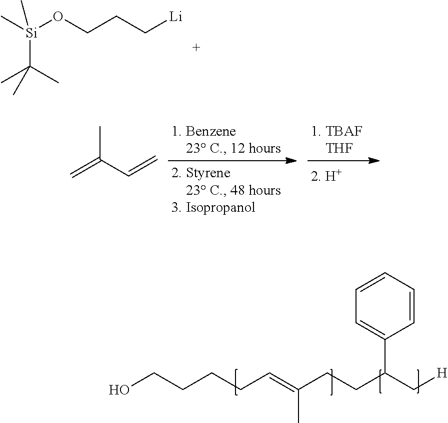

The following procedure is detailed for SI-OH-156A. Additional examples were prepared by altering reagent amounts as necessary. Anhydrous benzene (650 mL) and dry isoprene (21.75 g, 319 mmol) were added to a 1 L Schlenk flask equipped with stirbar. The solution was capped before TBDMSPL (0.40 mL, about 0.40 mmol) was added through the side-arm while stirring vigorously. Isoprene polymerization was allowed to proceed at room temperature for about 12 hours. Dry styrene (38.53 g, 370 mmol) was then introduced, resulting in an immediate change in the color of the reaction to light orange. The polymerization was allowed to stir at room temperature for an additional 48 hours before being quenched with degassed isopropanol.

The polymer solution was then reduced to dryness on a rotovap before the polymer was re-dissolved in about 500 mL THF. Once dissolved, TBAF (5.0 mL, 5 mmol, 12.5× excess) was added and the solution was stirred under nitrogen for more than 12 hours. Glacial acetic acid (about 20 mL) was then added to the polymer solution followed by precipitation of the polymer from methanol. The polymer was isolated by filtration, re-dissolved in THF and precipitated from methanol once more before being dried under high vacuum.

Other SI-OH precursor samples were synthesized as described for SI-OH-156A, except for differences in monomer and initiator ratio to obtain different polymer molecular weights and compositions. Details are given in Table 6.

TABLE 6

| | Mass % | Mass % | | |
|---|---|---|---|---|
| Sample ID | Isoprene | Styrene | GPC Mw (kg/mol) | GPC PDI |
| SI-OH-156A | 38.6 | 61.4 | 135 | 1.01 |
| SI-OH-156B | 31.2 | 68.8 | 146 | 1.01 |
| SI-OH-156C | 37.5 | 62.5 | 156 | 1.01 |
| SI-OH-156D | 35.8 | 64.2 | 221 | 1.01 |

Preparation of Poly(Isoprene-Styrene-Ethyleneoxide) Block Copolymer (PI-PS-PEO) (ISO)

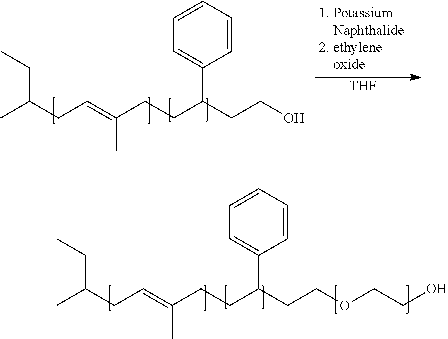

A 1 L polymerization reactor apparatus was constructed and inert Ar atmosphere established. IS-OH triblock copolymer (16.6 g, IS-023) was dissolved in about 100 mL benzene and freeze-dried. Tetrahydrofuran (319 g) was added to the reactor. The reactor was stirred and heated to 45° C. to dissolve the polymer.

Potassium naphthalenide initiator solution was prepared by adding a 10% molar excess of naphthalene and dry tetrahydrofuran solvent to potassium metal. The solution was stirred under an Ar atmosphere for at least 24 hrs, resulting in a dark green solution.

Potassium naphthalenide initiator solution was slowly added to reactor until a pale green color persisted for at least 30 minutes, indicating the endpoint of the titration. 1.8 g (41 mmol) of ethylene oxide was then added to the reactor and the reaction was allowed to proceed for approximately 96 hrs prior to termination with degassed methanol.

To isolate the solid polymer the tetrahydrofuran solvent was removed by rotary evaporation and the resulting polymer was dissolved in 400 mL of methylene chloride and washed with several 400 mL aliquots of distilled water. The methylene chloride solvent was removed by rotary evaporation and the resulting polymer was redissolved in 150 mL of benzene and freeze dried to yield approximately 16 g of off-white polymer designated ISO-026. Other ISO samples were synthesized as described for ISO-26, except for differences in precursor polymer and monomer ratios to obtain different polymer molecular weights and compositions.

Polymer composition was determined by ¹H-NMR, polymer molecular weight and polydispersity index by GPC analysis. Details are given in Table 7.

TABLE 7

| | | | | Mass % | | |
|---|---|---|---|---|---|---|
| | Precursor | Mass % | Mass % | Ethylene | GPC Mw | |
| Sample ID | Polymer | Isoprene | Styrene | oxide | (kg/mol) | GPC PDI |
| ISO-014 | IS-011 | 25.6 | 57.8 | 16.6 | 142 | 1.05 |
| ISO-015 | IS-011 | 26.0 | 58.7 | 15.4 | 139 | 1.02 |
| ISO-026 | IS-023 | 32.8 | 59.1 | 8.2 | 101 | 1.02 |

Preparation of Poly(Ethylene Oxide-Styrene-Isoprene-Styrene-Ethylene Oxide) Block Copolymer (OSISO)

OSISO block copolymers were prepared by the procedure described in PCT Pat. Publ. No. WO 2018/098023, pages 26-27 with differences in precursor polymer and monomer ratios necessary to obtain the desired polymer molecular weights and compositions. Polymer composition was determined by ¹H-NMR, and polymer molecular weight and polydispersity index (PDI) was determined by GPC analysis. Results are summarized in Table 8

TABLE 8

| | | | | Mass % | | |
|---|---|---|---|---|---|---|
| | Precursor | Mass % | Mass % | Ethylene | GPC Mw | |
| Sample ID | Polymer | Isoprene | Styrene | Oxide | (kg/mol) | GPC PDI |
| OSISO-016 | SIS-012 | 24.0 | 58.0 | 18.0 | 225 | 1.10 |
| OSISO-028 | SIS-024 | 31.6 | 60.7 | 7.7 | 99 | 1.05 |

Preparation of Poly(Styrene-Isoprene-Ethyleneoxide) Block Copolymer (PS-PI-PEO) (SIO)

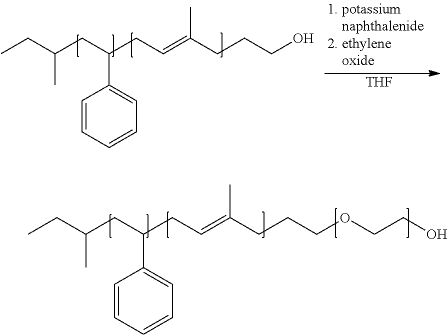

A 1 L polymerization reactor apparatus was constructed and inert Ar atmosphere established. IS-OH triblock copolymer (18.5 g, SI-052) was dissolved in about 100 mL benzene and freeze-dried. Tetrahydrofuran (380 g) was added to the reactor. The reactor was stirred and heated to 45° C. to dissolve the polymer.

Potassium naphthalenide initiator solution was prepared by adding a 10% molar excess of naphthalene and dry tetrahydrofuran solvent to potassium metal. The solution was stirred under an Ar atmosphere for at least 24 hrs, resulting in a dark green solution.

Potassium naphthalenide initiator solution was slowly added to reactor until a pale green color persisted for at least 30 minutes, indicating the endpoint of the titration. 2.7 g of ethylene oxide was then added to the reactor and the reaction was allowed to proceed for approximately 96 hrs prior to termination with degassed methanol.

To isolate the solid polymer the tetrahydrofuran solvent was removed by rotary evaporation and the resulting polymer was dissolved in 300 mL of methylene chloride and washed with several 400 mL aliquots of distilled water. The methylene chloride solvent was removed by rotary evaporation and the resulting polymer was redissolved in 150 mL of benzene and freeze dried to yield approximately 18 g of off-white polymer designated SIO-054. Other SIO samples were synthesized as described for SIO-054, except for differences in precursor polymer and monomer ratios to obtain different polymer molecular weights and compositions.

Polymer composition was determined by ¹H-NMR, polymer molecular weight and polydispersity index by GPC analysis. Details are given in Table 9.

TABLE 9

| | | | | Mass % | | |
|---|---|---|---|---|---|---|
| | Precursor | Mass % | Mass % | Ethylene | GPC Mw | |
| Sample ID | Polymer | Isoprene | Styrene | oxide | (kg/mol) | GPC PDI |
| SIO-054 | SI-052 | 28 | 61 | 10 | 143 | 1.03 |
| SIO-056 | SI-052 | 27 | 58 | 15 | 142 | 1.06 |
| SIO-064 | SI-156c | 32 | 56 | 12 | 169 | 1.05 |

Preparation of Poly(Ethylene Oxide-Isoprene-Styrene-Isoprene-Ethylene Oxide) Block Copolymer (OISIO)

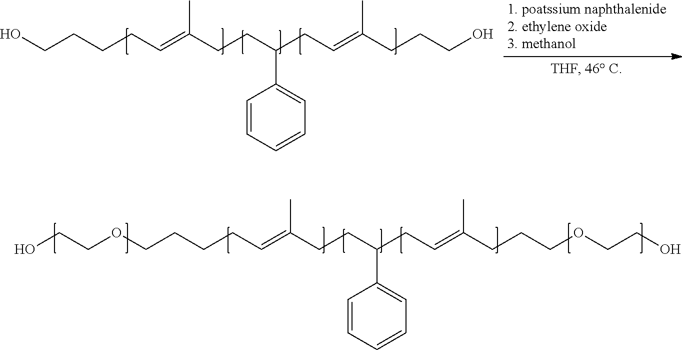

A 1 L polymerization reactor apparatus was constructed and inert Ar atmosphere established. HO-ISI-OH triblock copolymer (15.0 g, ISI-058) was dissolved in about 100 mL benzene added to the reactor and freeze-dried. Tetrahydrofuran (614 g) was added to the reactor. The reactor was stirred and heated to 45° C. to dissolve the polymer.

Potassium naphthalenide initiator solution was prepared by adding a 10% molar excess of naphthalene and dry tetrahydrofuran solvent to potassium metal. The solution was stirred under an Ar atmosphere for at least 24 hrs, resulting in a dark green solution.

Potassium naphthalenide initiator solution was slowly added to reactor until a pale green color persisted for at least 30 minutes, indicating the endpoint of the titration. Ethylene oxide (2.5 g) was added to the reactor and the reaction was allowed to proceed for approximately 72 hrs prior to termination with degassed methanol.

To isolate the solid polymer the tetrahydrofuran solvent was removed by rotary evaporation and the resulting polymer was dissolved in 300 mL of methylene chloride and washed with several 300 mL aliquots of distilled water. The methylene chloride solvent was removed by rotary evaporation and the resulting polymer was redissolved in 150 mL of benzene and freeze dried to yield an off-white polymer designated OISIO-061.

Polymer composition was determined by ¹H-NMR, polymer molecular weight and polydispersity index by GPC analysis. Details are given in Table 10.

TABLE 10

| | | | | Mass % | | |
|---|---|---|---|---|---|---|
| | Precursor | Mass % | Mass % | Ethylene | GPC Mw | |
| Sample ID | Polymer | Isoprene | Styrene | Oxide | (kg/mol) | GPC PDI |
| OISIO-061 | ISI-058 | 30 | 57 | 13 | 209 | 1.06 |

Imaging

Atomic Force Microscopy (AFM) Imaging

Atomic Force Microscopy (AFM) consists of a flexible cantilever with a sharp tip attached to the cantilever's free end. The sharp AFM tip is brought into contact with a sample and scanned in a raster pattern to generate a three-dimensional image of the sample's surface topography. This imaging technique is based on forces of interaction present between the tip and sample, which cause the cantilever to deflect as it scans across the surface. At each x-y position, the cantilever deflection is measured via a laser beam reflected off the cantilever's backside and detected by a photodiode. The z(x,y) data is used to construct a three-dimensional topography map of the surface. In Tapping Mode AFM, the tip/cantilever assembly is oscillated at the resonant frequency of the cantilever; the amplitude of vertical oscillation is the input parameter for the feedback loop. In a topographic AFM image, “brighter regions” correspond to peaks while “darker regions” correspond to valleys. The phase data is the phase difference between the photodiode output signal and driving excitation signal and is a map of how the phase of the AFM cantilever oscillation is affected by its interaction with the surface. The physical meaning of the phase signal is complex and contrast is generally influenced by material property differences such as composition, adhesion, viscoelasticity and may also include topographical contributions. For imaging in water environment, Peak Force Tapping Mode was used. Unlike the traditional Tapping Mode, Peak Force Tapping Mode operates in a non-resonant mode; the cantilever is driven to oscillation at a fixed frequency (2 kHz modulation in z) and a fast force curve is performed at each pixel of an AFM image. The feedback mechanism in Peak Force Tapping uses the “peak force” setpoint or maximum force sensed by the tip as it contacts the surface. Since there is no need for cantilever tuning, this AFM mode is substantially easier to perform in liquid environment.

Imaging was performed using, interchangeably, one of two AFM instruments (obtained under the trade designations “DIMENSION ICON AFM” and “DIMENSION FASTSCAN AFM” from Bruker, Billerica, Mass.) along with a controller (obtained under the trade designation “NANOSCOPE V” from Bruker, Billerica, Mass.) and software (obtained under the trade designation “NANOSCOPE 8.15” from Bruker, Billerica, Mass.). The “DIMENSION FASTSCAN AFM” instrument was used, interchangeably, with one of two tapping mode probes (obtained under the trade designations “FASTSCAN A” from Bruker, Billerica, Mass. [f₀=1.4 MHz, k=18 N/m, tip radius (nom)=5 nm] and “OTESPA R3” from Bruker, Billerica, Mass. [f₀=300 kHz, k=26 N/m, tip radius (nom)=7 nm]). The “DIMENSION ICON AFM” instrument was used only with the “OTESPA R3” probe. For the purposes of the tests described in these Examples, results are believed to be equivalent regardless of which of the AFM instruments and which of the probes was employed. The tapping setpoint was typically 85% of the free air amplitude. All AFM imaging was performed under ambient conditions. Software (obtained under the trade designation “SPIP 6.5.1” from Image Metrology A/S, Horsholm, Denmark) was used for image processing and analysis. Generally, images were processed with a first order planefit to remove sample tilt and with a 0th order flatten to remove z-offsets or horizontal skip artifacts. In some cases, to enhance visualization of features, the images were processed with a 3rd order planefit to remove tilt and bow, or processed with an L-filter to remove background waviness.

Scanning Electron Microscopy (SEM) Imaging

The samples for surface images were mounted on conductive carbon tape tabs. The tabs were mounted on an SEM stub and a thin coating of AuPd (20 mA/25 sec) was deposited to make them conductive. Imaging was conducted at 2 kv, and 4 mm or 5 mm wd, with an SE detector and in Low Mag Mode, with no tilt, at 30kx or 100kx magnification. A field emission scanning electron microscope (obtained under the trade designation “HITACHI SU-8230” from Hitachi High-Technologies, Tokyo, Japan) was used for imaging. Cross-sections of samples for cross-sectional images were made by cutting under liquid nitrogen and were mounted for examination. A thin coating of Ir (1.8 nm) was deposited to make the samples conductive. Conditions used were 2kv, 4 mm wd, with an SEI detector, with no tilt, and magnifications employed included: 10kx, 30kx, and 70kx.

Membrane Preparation

Materials used in Membrane Preparation are summarized in Table 11.

TABLE 11

| | Product Code | |
|---|---|---|
| Abbreviation/ | or Trade | |
| Chemical Name | Designation | Source |
| DMAc (N,N- | A10924 | Alfa Aesar, Ward Hill, MA |
| Dimethylacetamide) | | |
| DMF (Dimethyl | 22915 | Alfa Aesar, Ward Hill, MA |
| formamide) | | |
| MEK (Methyl ethyl | BK1670-3 | EMD Millipore Corp., |
| ketone) | | Billerica, MA |
| NMP (1-Methyl-2- | 43894 | Alfa Aesar, Ward Hill, MA |
| pyrrolidinone) | | |
| THF (Tetrahydrofuran) | TX0282-1 | EMD Millipore Corp., |
| | | Billerica, MA |
| Sulf (Sulfolane) | A13466 | Alfa Aesar, Ward Hill, MA |
| MeTHF (2- | 673277 | Sigma-Aldrich Co. LLC., St. |
| Methyltetrahydrofuran) | | Louis, MO |

### Examples 1-18

Casting of ISO-14, ISO-15 and ISO-26 Materials

ISO-14, ISO-15 and ISO-26 block copolymers were dissolved in various solvents or solvent mixtures at concentrations from 12 wt. % to 18 wt. % and cast using a coating gap of 8 mils (203.2 micrometers) with evaporation periods from 0 seconds to 60 seconds. After immersion into a water bath to form membranes, observations of qualities of the membranes were made and recorded. Some formed clear or scattering gel coatings which dried to clear brittle coatings. Some formed opaque structures. Examination of the ISO-26 MeTHF/NMP coating surfaces by AFM revealed large micron-scale structures. Results are summarized in Table 12.

TABLE 12

| | | | | Evap. | |
|---|---|---|---|---|---|
| Ex. | | Solvent | Concentration | Time | |
| No. | Polymer | (parts by wt) | (wt. %) | (sec) | Observations |
| 1 | ISO-14 | 60/40 THF/DMF | 12 | 0 | Gelled, dried clear |
| 2 | ISO-14 | 60/40 THF/DMF | 12 | 20 | Gelled, dried clear |
| 3 | ISO-14 | 60/40 THF/DMF | 12 | 40 | Gelled, dried clear |
| 4 | ISO-14 | 60/40 THF/DMF | 18 | 10 | Gelled, dried clear |
| 5 | ISO-14 | 60/40 THF/DMF | 18 | 20 | Gelled, dried clear |
| 6 | ISO-14 | 40/60 NMP/THF | 15 | 20 | Gelled, dried clear |
| 7 | ISO-14 | 49/29/23 THF/DMAc/Sulf | 12 | 0 | Gelled, dried clear |
| 8 | ISO-14 | 49/29/23 THF/DMAc/Sulf | 12 | 10 | Gelled, dried clear |
| 9 | ISO-14 | 49/29/23 THF/DMAc/Sulf | 12 | 20 | Gelled, dried clear |
| 10 | ISO-14 | THF | 18 | 0 | Opaque, very matte |
| 11 | ISO-14 | THF | 18 | 10 | Opaque/Translucent |
| 12 | ISO-14 | THF | 18 | 20 | Gelled, dried clear |
| 13 | ISO-15 | 60/40 THF/DMF | 12 | 20 | Gelled, dried clear |
| 14 | ISO-15 | 60/40 THF/DMF | 12 | 40 | Gelled, dried clear |
| 15 | ISO-26 | 60/40 THF/DMF | 15 | 30 | Gelled |
| 16 | ISO-26 | 60/40 THF/DMF | 15 | 60 | Gelled |
| 17 | ISO-26 | 70/30 MeTHF/NMP | 12 | 10 | Opaque, cracks |
| 18 | ISO-26 | 70/30 MeTHF/NMP | 12 | 20 | Opaque, cracks |

### Examples 19-38

Casting of OSISO-16 and OSISO-28 Materials

OSISO-16 and OSISO-28 pentablock copolymers were dissolved in various solvent mixtures at concentrations from 12 wt. % to 18 wt. % and cast using a coating gap of 8 mils (203.2 micrometers) with evaporation periods from 0 seconds to 60 seconds. A range of results were observed and recorded, including disintegration, gelation resulting in clear dry films, and opaque films with pore structures (that is, membranes). Samples that did not disintegrate remained attached to the plastic coating support. Results are summarized in Table 13

TABLE 13

| | | | | Evap. | | |
|---|---|---|---|---|---|---|
| Ex. | | Solvent | Concentration | Time | | Appearance |
| No. | Polymer | (parts by wt) | (wt %) | (sec) | Observations | by AFM |
| 19 | OSISO-16 | 60/40 THF/DMF | 12 | 20 | Dried clear | — |
| 20 | OSISO-16 | 60/40 THF/DMF | 12 | 40 | Dried clear | — |
| 21 | OSISO-28 | 50/50 MeTHF/NMP | 18 | 0 | Opaque | Some pores |
| 22 | OSISO-28 | 50/50 MeTHF/NMP | 18 | 20 | Opaque/translucent | — |
| 23 | OSISO-28 | 50/50 MeTHF/NMP | 18 | 40 | Dried clear | — |
| 24 | OSISO-28 | 70/30 MeTHF/NMP | 18 | 10 | Opaque | Some pores |
| 25 | OSISO-28 | 70/30 MeTHF/NMP | 18 | 20 | Translucent | Open pore |
| | | | | | | structure |
| 26 | OSISO-28 | 70/30 MeTHF/NMP | 18 | 40 | Translucent | — |
| 27 | OSISO-28 | 70/30 MeTHF/NMP | 21 | 20 | Translucent | Wormlike |
| | | | | | | structures |
| 28 | OSISO-28 | 70/30 MeTHF/NMP | 21 | 40 | Opaque | Wormlike |
| | | | | | | structures |
| 29 | OSISO-28 | 70/30 MeTHF/NMP | 21 | 60 | Translucent | — |
| 30 | OSISO-28 | 25/25/50 MeTHF/NMP | 18 | 0 | Opaque | — |
| 31 | OSISO-28 | 25/25/50 MeTHF/NMP | 18 | 20 | Clear/translucent | — |
| 32 | OSISO-28 | 25/25/50 MeTHF/NMP | 18 | 40 | Dried clear | — |
| 33 | OSISO-28 | 50/38/12 MEK/DMAc/Sulf | 12 | 20 | Disintegrated | — |
| 34 | OSISO-28 | 50/38/12 MEK/DMAc/Sulf | 15 | 20 | Disintegrated | — |
| 35 | OSISO-28 | 100/38/12 MEK/DMAc/Sulf | 15 | 20 | Disintegrated | — |
| 36 | OSISO-28 | 150/38/12 MEK/DMAc/Sulf | 15 | 20 | Disintegrated | — |
| 37 | OSISO-28 | 200/38/12 MEK/DMAc/Sulf | 15 | 0 | Disintegrated | — |
| 38 | OSISO-28 | 200/38/12 MEK/DMAc/Sulf | 15 | 20 | Disintegrated | — |

### Examples 39-52

Casting of SIO-54 Materials

SIO-54 triblock copolymer was dissolved in 70/30 (parts by wt) MEK/DMF at concentrations from 12 wt. % to 18 wt. % and cast using a coating gap of 8 mils (203.2 micrometers) with evaporation periods from 5 seconds to 20 seconds. The coatings became opaque and detached from the plastic support sheet while in the bath. Following removal from the water bath and drying, a subset of samples was examined by AFM to assess the surface morphology. Samples were evaluated for wetting by a sessile water drop. Some samples exhibited an ordered, nanoscale dot structure. These were further examined by high-resolution SEM. By SEM, the dot features in samples made with evaporation periods of 5 s or 10 s were not obvious, but they could be seen in the samples made with an evaporation period of 15 s, although very few of the features appeared to be open pores. Results are summarized in Table 14.

TABLE 14

| | Concen- | Evap. | | |
|---|---|---|---|---|
| Ex. | tration | Time | | Wetting |
| No. | (wt. %) | (sec) | Appearance by AFM | by water |
| 39 | 12 | 10 | — | Yes |
| 40 | 12 | 15 | — | Yes |
| 41 | 12 | 20 | — | Yes |
| 42 | 12 | 25 | — | Yes |
| 43 | 14 | 5 | — | Yes |
| 44 | 14 | 10 | — | No |
| 45 | 14 | 15 | — | No |
| 46 | 14 | 20 | — | No |
| 47 | 16 | 5 | Nanoscale structures | No |
| 48 | 16 | 10 | Nanoscale structures | No |
| 49 | 16 | 15 | Nanoscale structures | No |
| 50 | 18 | 5 | Nanoscale ordered dot structures | Yes |
| 51 | 18 | 10 | Nanoscale ordered dot structures | Yes |
| 52 | 18 | 15 | Nanoscale ordered dot structures | Yes |

### Examples 53-63

Casting of SIO-56 Materials

SIO-56 triblock copolymer was dissolved in 70/30 (parts by wt) MEK/DMF at concentrations from 14 wt. % to 17 wt. % and cast using a coating gap of 8 mils (203.2 micrometers) with evaporation periods from 5 seconds to 20 seconds. The coatings became opaque and detached from the plastic support sheet while in the bath. Following removal from the water bath and drying, samples were examined by AFM to assess the surface morphology. Samples were evaluated for wetting by a sessile water drop. Some samples Examples 56, 58, 59, 60, and 62 were also examined by high-resolution SEM and unmistakable hexagonally-packed dot features were observed, but they did not appear to be open pores. Results are summarized in Table 15.

TABLE 15

| | Concen- | Evap. | | |
|---|---|---|---|---|
| Ex. | tration | Time | | Wetting |
| No. le | (wt. %) | (sec) | Appearance by AFM | by water |
| 53 | 14 | 5 | Nanoscale structures | Yes |
| 54 | 14 | 10 | Nanoscale ordered dot structures | Yes |
| 55 | 14 | 15 | Nanoscale ordered dot structures | Yes |
| 56 | 14 | 20 | Nanoscale ordered dot structures | Yes |
| 57 | 16 | 5 | Nanoscale dot structures | No |
| 58 | 16 | 15 | Nanoscale ordered dot structures | Yes |
| 59 | 16 | 20 | Nanoscale ordered dot structures | No |
| 60 | 16 | 25 | Nanoscale ordered dot structures | No |
| 61 | 17 | 5 | Nanoscale dot structures | Yes |
| 62 | 17 | 10 | Nanoscale ordered dot structures | Yes |
| 63 | 17 | 15 | Nanoscale ordered dot structures | Yes |

### Examples 64-72

Casting of SIO-64 Materials

SIO-64 triblock copolymer was dissolved in 70/30 (parts by wt) THF/DMF at concentrations from 14 wt. % to 16 wt. % and cast using a coating gap of 8 mils (203.2 micrometers) with evaporation periods from 5 seconds to 25. The coatings became opaque and detached from the plastic support sheet while in the bath. Following removal from the water bath and drying, samples were examined by AFM to assess the surface morphology. Samples were evaluated for wetting by a sessile water drop. All samples exhibited nanoscale structures of about 20 nm. Examples 64, 65, 69, and 70 exhibited nanoscale ordered dot structures. None of these samples were wetting by water. Results are summarized in Table 16.

TABLE 16

| | Concen- | Evap. | | |
|---|---|---|---|---|
| Ex. | tration | Time | | Wetting |
| No. | (wt. %) | (sec) | Appearance by AFM | by water |
| 64 | 14 | 10 | Some nanoscale ordered dot | No |
| | | | structures | |
| 65 | 14 | 15 | Some nanoscale ordered dot | No |
| | | | structures | |
| 66 | 14 | 20 | Nanoscale structures | No |
| 67 | 14 | 25 | Nanoscale structures | No |
| 68 | 16 | 5 | Nanoscale structures | No |
| 69 | 16 | 10 | Some nanoscale ordered dot | No |
| | | | structures | |
| 70 | 16 | 15 | Some nanoscale ordered dot | No |
| | | | structures | |
| 71 | 16 | 20 | Nanoscale dot structures | No |
| 72 | 16 | 25 | Nanoscale structures | No |

### Examples 73-76

Attempts to Cast OISIO-61 Materials

OISIO-61 pentablock copolymer was dissolved in various MEK/DMF and THF/DMF solvent mixtures at concentrations from 9 wt. % to 14 wt. %. For the MEK/DMF system, it was found that the solutions either phase separated (at 12 wt. % and at 14 wt. %) or gelled (at 9 wt. % and at 11 wt. %). For the THF/DMF system, it was observed that solutions with 50% (by volume) or less of THF in the mixed solvent gelled. Those at higher THF content in the mixed solvent, and lower concentrations of the polymer, could be cast into coatings, but formed translucent or clear cohesive films. Results are summarized in Table 17.

TABLE 17

| | | Concen- | Evap. | |
|---|---|---|---|---|
| Ex. | Solvent | tration | Time | |
| No. | (parts by wt) | (wt. %) | (sec) | Comments |
| 73 | 60/40 THF/DMF | 9 | 5 | Gelled/Translucent |
| 74 | 60/40 THF/DMF | 9 | 10 | Gelled/Translucent |
| 75 | 60/40 THF/DMF | 9 | 15 | Gelled/Translucent |
| 76 | 70/30 THF/DMF | 9 | 10 | Gelled/Translucent |

All references and publications cited herein are expressly incorporated herein by reference in their entirety into this disclosure. Illustrative embodiments of this invention are discussed and reference has been made to possible variations within the scope of this invention. For example, features depicted in connection with one illustrative embodiment may be used in connection with other embodiments of the invention. These and other variations and modifications in the invention will be apparent to those skilled in the art without departing from the scope of the invention, and it should be understood that this invention is not limited to the illustrative embodiments set forth herein. Accordingly, the invention is to be limited only by the claims provided below and equivalents thereof.

1. A porous membrane comprising a triblock copolymer of the formula ABC, the porous membrane comprising a plurality of pores;
wherein the A block has a T_{g} of 90 degrees Celsius or greater and is present in an amount ranging from 30% to 80% by weight, inclusive, of the total block copolymer;
wherein the B block has a T_{g} of 25 degrees Celsius or less and is present in an amount ranging from 10% to 40% by weight, inclusive, of the total block copolymer and
wherein the C block is a water miscible hydrogen-bonding block immiscible with each of the A block and the B block;
wherein the porous membrane comprising a first major surface and an opposed second major surface, wherein the first major surface is a nanostructured surface.

2. The porous membrane of claim 1, wherein the nanostructured surface comprises a plurality of anisotropic nanostructures or nanoscale phase separated regions.

3. The porous membrane of claim 1, wherein the nanostructured surface has a density of 1×10¹³-1×10¹⁵ nanostructures per cm².

4. The porous membrane of claim 1, wherein the A block comprises a polystyrene.

5. The porous membrane of claim 1, wherein the B block comprises a polyisoprene.

6. The porous membrane of claim 1, wherein the C block comprises a poly(ethylene oxide).

7. The porous membrane of claim 1, wherein the membrane is isoporous.

8. The porous membrane of claim 1, wherein the porous membrane is an integral asymmetric membrane.

9. A method of preparing a porous membrane, the method comprising:
forming a film or a hollow fiber from a solution, the solution comprising a solvent and solids comprising an ABC triblock copolymer;
removing at least a portion of the solvent from the film or the hollow fiber; and
contacting the film or the hollow fiber with a nonsolvent, thereby forming the porous membrane comprising a plurality of pores;
forming the porous membrane comprising a plurality of pores;
wherein the A block has a T_{g} of 90 degrees Celsius or greater and is present in an amount ranging from 30% to 80% by weight, inclusive, of the total block copolymer;
wherein the B block has a T_{g} of 25 degrees Celsius or less and is present in an amount ranging from 10% to 40% by weight, inclusive, of the total block copolymer and
wherein the C block is a water miscible hydrogen-bonding block immiscible with each of the A block and the B block.

10. The method of claim 9, wherein the A block comprises a polystyrene, the B block comprises a polyisoprene and the C block comprises a poly(ethylene oxide).

11. The method of claim 9, wherein the solvent is selected from the group consisting of dimethylformamide, dimethylacetamide, N-methylpyrrolidone, dim ethyl sulfoxide, tetrahydrofuran, 1,4-dioxane, 1,3-dioxane, tetrahydrothiophene 1,1-dioxide, methyl ethyl ketone, methyl tetrahydrofuran, sulfolane, and combinations thereof.

12. The method of claim 9, wherein the solvent is a blend of 70/30 methyl ethyl ketone and dimethylformamide.

13. The method of claim 9, further comprising removing at least a portion of the solvent between 10 milliseconds and 2 mins.

14. The method of claim 9, wherein forming the film comprises casting the solution on a substrate.
